(19) United States
(12) Patent Application Publication
(10) Pub. No.: US 2009/0013595 A1
(43) Pub. Date: Jan. 15, 2009

(54) Modular Biodegradable Garden Environment Control System and Method

(76) Inventor: David Hoch, Belmont, MA (US)

Correspondence Address: Richman and Associates, P.O. Box 3333, La Jolla, CA, 92038-3333, US

(21) Appl. No.: 11/777,994

(22) Filed: Jul. 13, 2007

(51) Int. Cl. A01C 1/04; A01G 7/00

(52) U.S. Cl. 47/9; 156/60; 47/56

(57) ABSTRACT

Modular biodegradable garden environment control system and method including apparatus to limit soil exposure to light nearby one or more plants, including one or more layers of a biodegradable material.

### BACKGROUND

1. Field of the Invention

The invention relates generally to gardening systems and methods, and more particularly, to garden environment maintenance or containment systems and methods.

2. Description of Related Art

It may be desirable to control the light, bug exposure, moisture level, weed growth, and temperature near or about one or more plants in a soil bed. The present invention provides such a system and method.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1A is a simplified top view diagram of a biodegradable soil cover in accordance with an embodiment of the present invention;

FIG. 1B is a simplified side view diagram of the biodegradable soil cover as shown in FIG. 1A;

FIG. 1C is a simplified top view diagram of the biodegradable soil cover as shown in FIG. 1A including multiple stake openings;

FIG. 2A is a simplified top view diagram of another biodegradable soil cover in accordance with an embodiment of the present invention;

FIG. 2B is a simplified side view diagram of the biodegradable soil cover as shown in FIG. 2A;

FIG. 3 is a simplified side view diagram of a biodegradable ground stake in accordance with an embodiment of the present invention;

FIG. 4A is a simplified top view diagram of the biodegradable soil cover shown in FIG. 1A including perimeter weights;

FIG. 4B is a simplified side view diagram of the biodegradable soil cover as shown in FIG. 4A;

FIG. 5A is a simplified top view diagram of the biodegradable soil cover shown in FIG. 1A including embedded seeds, fertilizer, or insect repellant;

FIG. 5B is a simplified side view diagram of the biodegradable soil cover as shown in FIG. 5A;

FIG. 6A is a simplified top view diagram of the biodegradable soil cover as shown in FIG. 1A including multiple perforations;

FIG. 6B is a simplified top view diagram of the biodegradable soil cover as shown in FIG. 1A including saddle stitching along the perimeter;

FIG. 6C is a simplified top view diagram of the biodegradable soil cover as shown in FIG. 1A including several plant spacing graphics;

FIG. 6D is a simplified top view diagram of the biodegradable soil cover as shown in FIG. 1A including several grid lines;

FIG. 6E is a simplified top view diagram of the biodegradable soil cover as shown in FIG. 1A including several fold areas; and

FIG. 7 is a simplified top diagram of a biodegradable soil cover architecture including three biodegradable soil covers shown in FIG. 1A in a configuration in accordance with an embodiment of the present invention.

### DETAILED DESCRIPTION

Throughout this description, embodiments and variations are described for the purpose of illustrating uses and implementations of the invention. The illustrative description should be understood as presenting examples of the invention, rather than as limiting the scope of the invention.

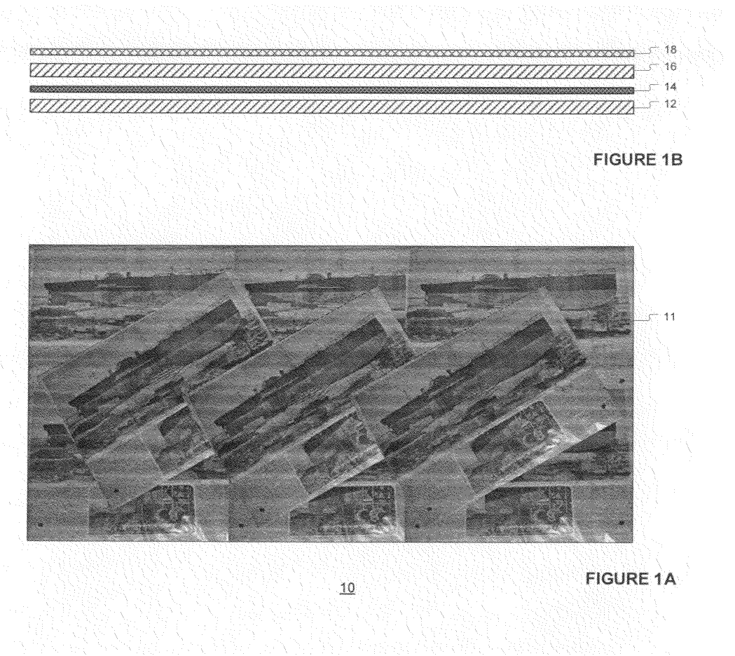

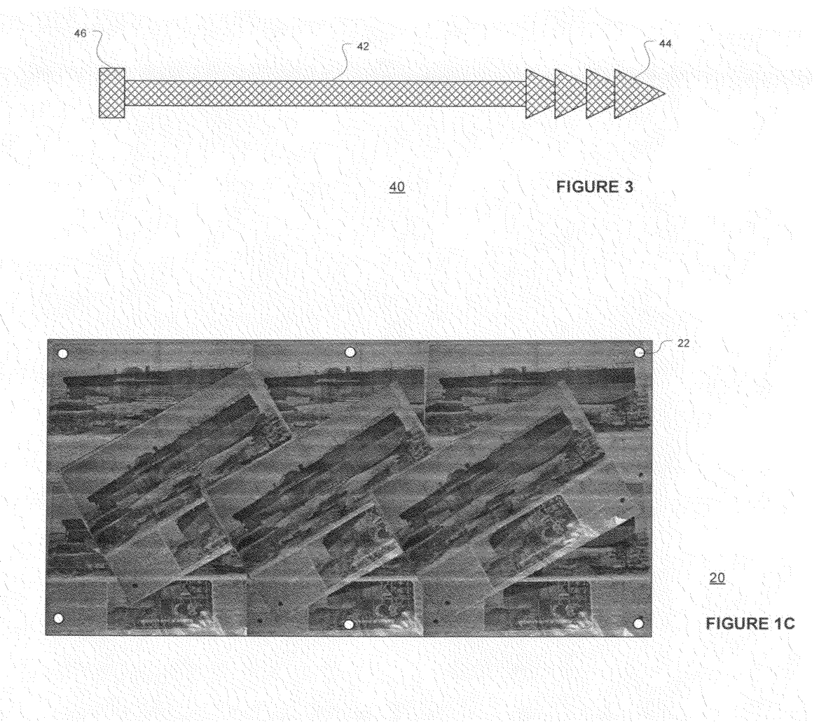

FIG. 1A is a simplified top view diagram of a biodegradable soil cover 10 in accordance with an embodiment of the present invention and FIG. 1B is a simplified side view diagram of the biodegradable soil cover 10 as shown in FIG. 1A. In an embodiment the soil cover 10 may be comprised of newspaper sheets 11 or other relatively flat biodegradable products (such as plant leaves). The soil cover 10 may include a plurality of layers 12, 14, 16, and 18 where the first layer 12 and third layer 16 may be comprised of biodegradable paper 11. In an embodiment the soil cover 10 may include a single biodegradable material layer 12. The bottom layer 12 may also be coated with a weed specific suppression agent such as copper. The second layer 14 may be a biodegradable paper binding agent including a milk based or other biodegradable glue product that is harmless to soil (e.g. Elmer's® Glue). The soil cover may also include a fourth layer 18. The fourth layer 18 may also include a biodegradable binding agent. The fourth layer 18 may also biodegradable inks and fertilizer(s) that are applied to at least the third layer 16. The biodegradable inks or dyes may include soy based or iron based ink. The inks and fertilizers may be used to color the soil cover 10 to a desired ground color including hues of green and brown. The fourth layer may also comprise an organic barrier that protects any dyes from moistures and limits adhesion of the soil cover to other objects including shoes.

In operation a user may place the soil cover 10 over a patch of cultivated soil. One or more openings may be made in the soil cover 10 to enable the planting of seed(s), or seedlings, or plants. The remaining, unopened soil cover 10 may promote solar radiation below the first layer 12 and may limit water vapor passage from the first layer 12 to the upper layers 16, 18. Accordingly the soil cover 10 may limit undesired growth in unopened areas and maintain or enable hydration and aerification. In an embodiment the paper 11 layers and glue layers 14 may be formed to a thickness that enables the soil cover 10 to be stable over a normal growing season cycle, i.e. for 3 to 4 months. Thereafter the soil cover 10 may erode or biodegrade and be absorbed into the underlying soil. Accordingly at the end of a plant growth season a user may not need to remove the soil cover 10 as the cover 10 naturally erodes to mulch. A user may also till the soil cover 10 into the underlying soil at the end of a planting season or cycle.

FIG. 1C is a simplified top view diagram of the biodegradable soil cover 20 as shown in FIG. 1A including multiple stake openings 22. The soil cover 20 may include stake openings at one or more corners and midsections 22 to help keep the soil cover 20 adjacent to soil to be protected or covered. FIG. 3 is a simplified side view diagram of a biodegradable ground stake 40 in accordance with an embodiment of the present invention. The stake 40 may include a central shaft 42, serrated tips 44, and end cap 46. In an embodiment the stake may be formed from one or more biodegradable materials including corn husks or stalks, biodegradable plastics, wood based materials, or other biodegradable plant products. The stake 40 may also include one or more organic nutrients that are released to adjacent soil as the stake biodegrades. As shown in FIG. 7 and discussed below one or more stakes 40 may be employed in stake openings 22 that may be overlapped in multiple cover 20 architectures 130.

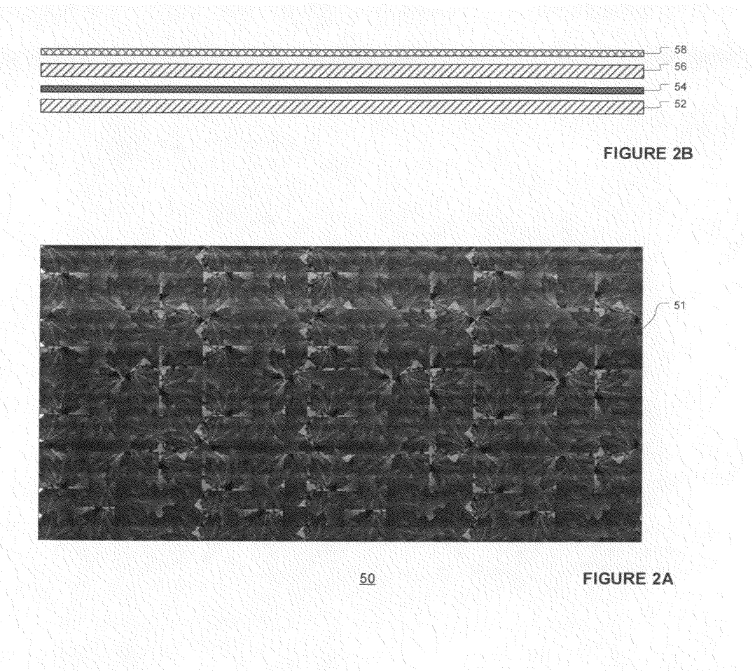

FIG. 2A is a simplified top view diagram of another biodegradable soil cover 50 in accordance with an embodiment of the present invention and FIG. 2B is a simplified side view diagram of the biodegradable soil cover 50 as shown in FIG. 2A. In an embodiment the soil cover 50 may be comprised of a plurality of leaves 51. The soil cover 50 may include a plurality of layers 52, 54, 56, and 58 where the first layer 52 and third layer 56 may be comprised of a plurality of leaves 51. The leaves 51 may include maple, tobacco leaves or other tree or plant based leaves or other substantially flat organic and biodegradable material. The second layer 54 may be a biodegradable leaf binding agent including a milk based glue product. The soil cover 50 may also include a fourth layer 58. The fourth layer 58 may also include a biodegradable binding agent. The fourth layer 58 may also biodegradable inks that are applied to at least the third layer 56. The biodegradable inks may include soy based or iron oxide based dyes. The inks may be used to color the soil cover 50 to a desired ground color including hues of green and brown. As described below one or more inks may be employed to add graphics, logo, grids, planting information, or other nomenclature.

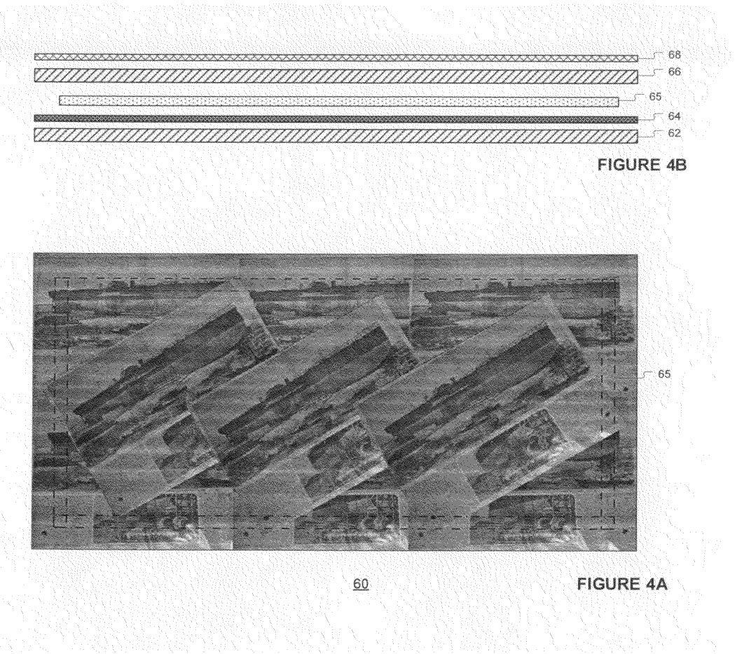

FIG. 4A is a simplified top view diagram of the biodegradable soil cover 60 shown in FIG. 1A including embedded perimeter weights 65 and FIG. 4B is a simplified side view diagram of the biodegradable soil cover 60 as shown in FIG. 4A. The soil cover 60 may include a first layer 62, second layer 64, weighted perimeter 65, third layer 66, and fourth layer 68 where layer 62, 64, 66, and 68 may correspond to layers 12, 14, 16, and 18 as shown in FIGS. 1A and 1B. The weighted perimeter 65 may be comprised of biodegradable material including sand. The perimeter 65 may be located about the entire soil cover 60 periphery as show in FIG. 4A or at least the corners.

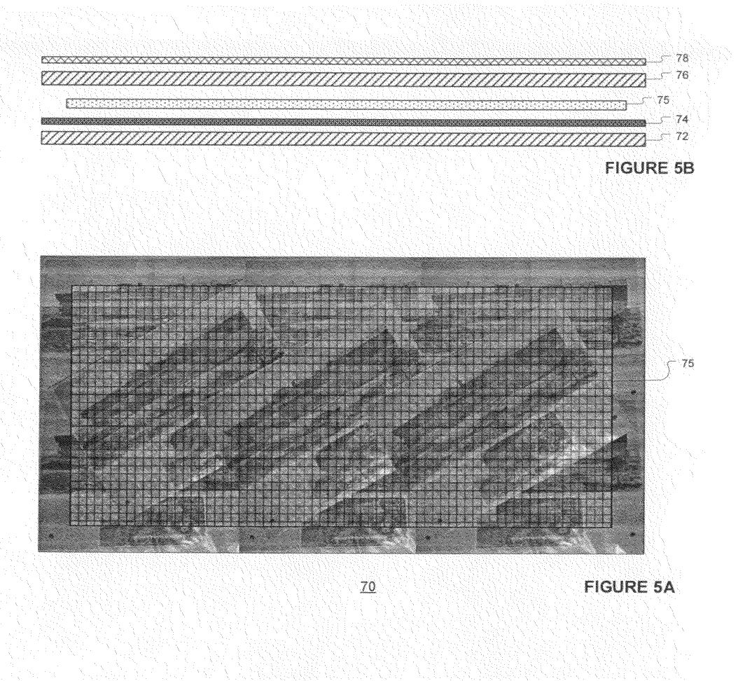

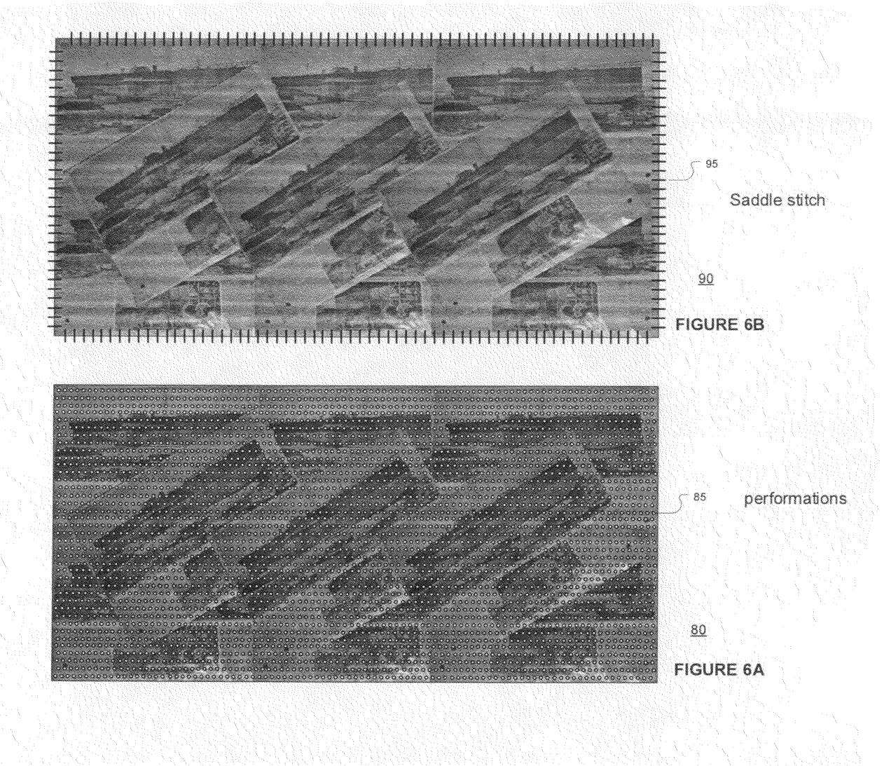

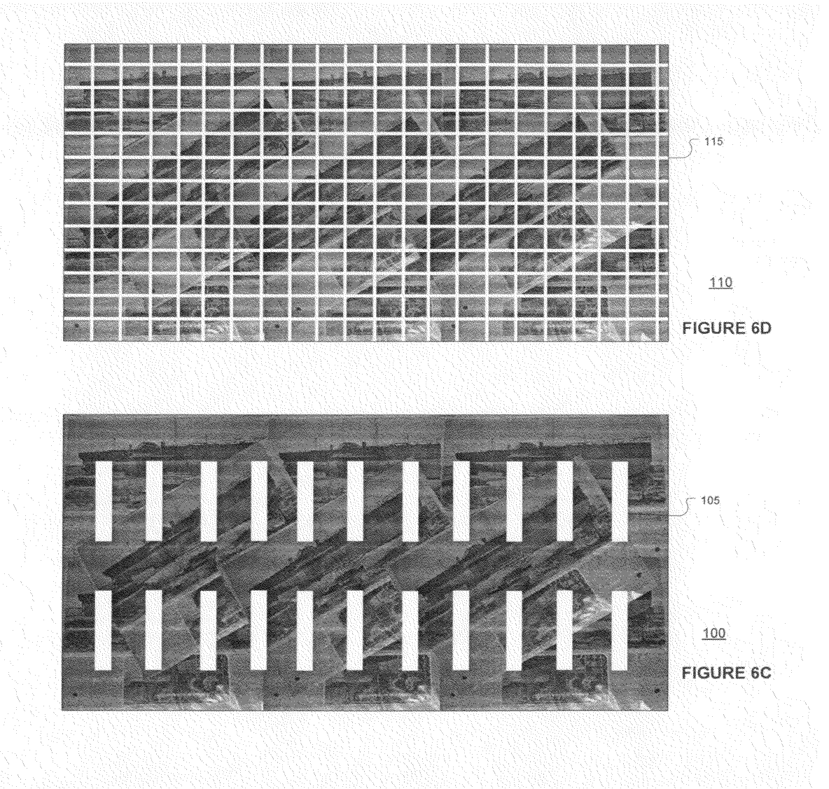

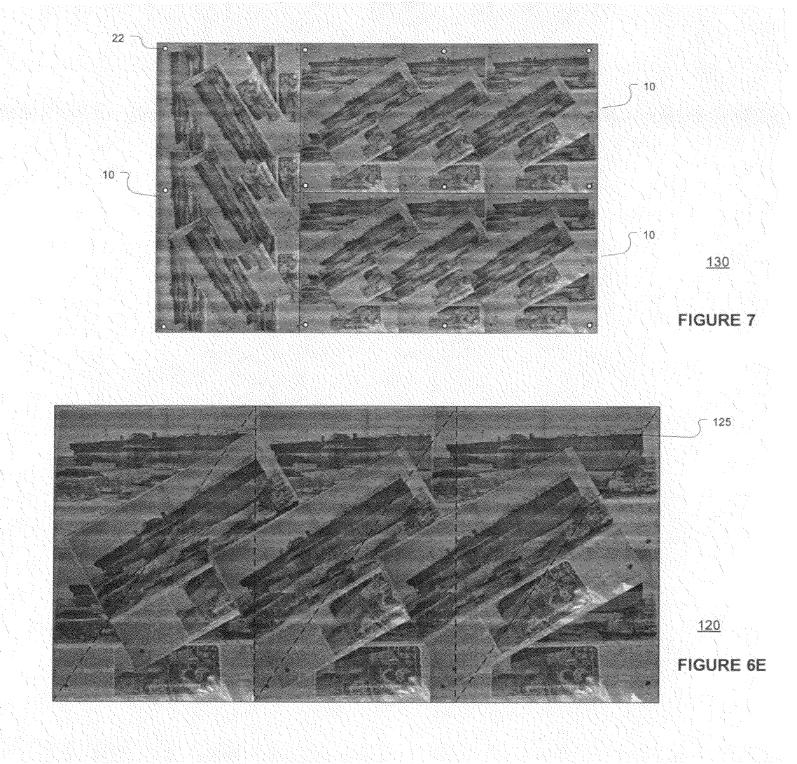

FIG. 5A is a simplified top view diagram of the biodegradable soil cover 70 shown in FIG. 1A including one of an embedded section 75. The embedded section may include seeds, fertilizer, and insect repellant 75. FIG. 5B is a simplified side view diagram of the biodegradable soil cover 70 as shown in FIG. 5A. The soil cover 70 may include a first layer 72, second layer 74, an embedded section 75, a third layer 76, and a fourth layer 78 where layer 72, 74, 76, and 78 may correspond to layers 12, 14, 16, and 18 as shown in FIGS. 1A and 1B. The embedded section 75 may be located about the entire soil cover 60 as show in FIG. 4A or in discrete locations such as the row patches 105 shown in FIG. 6C. Further the embedded section 75 may be located about the entire soil cover 60 other than discrete locations such as the row patches 105 shown in FIG. 6C or gridz 115 (FIG. 6D). In such a configuration the embedded section may include seeds, fertilizer, and insect repellant so another carpet type plant (low height grass) or aesthetically pleasing plant may form other than desired locations. The plant may biodegrade after a growing section to provide nutrients and fertilizer to adjacent soil.

In an embodiment the embedded section 75 may include a combination of seeds, fertilizer, and insect repellant. The fertilizer may be a slow-release, UV-resistant, organic fertilizer. The insect repellant may an organic product including Caspian. The embedded section may also include water absorbing or hydration crystals that expand and hold water when subjected to hydration. The hydration crystals may help maintain a desired hydration level during dry spells and may also provide weight, which may further secure the soil cover to soil.

FIG. 6A is a simplified top view diagram of the biodegradable soil cover 80 as shown in FIG. 1A including multiple perforations 85. The perforations 85 may be located about the entire soil cover 80 as show in FIG. 6A, in discrete locations such as the row patches 105 shown in FIG. 6C, or along grids 115 shown in FIG. 6D. The perforations may be sized to enable hydration and aerification to the underlying soil while limiting or preventing non-desired plant growth by limiting light transmission to the underlying soil.

FIG. 6B is a simplified top view diagram of the biodegradable soil cover 90 as shown in FIG. 1A including saddle stitching 95. The saddle stitching 95 may be located about the entire soil cover 90 periphery as show in FIG. 6B or at least the corners. The stitching 95 may prevent premature degradation of the cover edges. In an embodiment a soil cover may include one or more graphics such as shown in FIG. 6C and FIG. 6D. FIG. 6C is a diagram of a top cover of a soil cover 100 including row patches 105. The row patches 105 may also include printed nomenclature indicating planting information or recommendations. The nomenclature may employ different dyes or colors to indicate plant spacings and other information. The patches may also change color or include some other visible indication that is related to the amount of radiation and moisture (rain) that has contacted the patch(es) 105. One or more of the patches may also be a waterproof or opaque radiation proof storage pouch. A user may leave extra seeds or other items that may be damaged by water or sunlight. Such pouches may be easily removed from the soil cover. FIG. 6D is a diagram of a top cover of a soil cover 110 including grid lines 115. The graphics 105, 116 may be located about the entire soil cover 60 as show in FIGS. 6C and 6D or limited locations. In an embodiment the grid lines 115 may include repeated every three to six inches.

In an embodiment the soil covers 10, 20, 50, 60, 70, 80, 90, 100, and 110 may be rolled along their width or length to enable transportation of the cover to desired location(s). In an embodiment the soil covers 10, 20, 50, 60, 70, 80, 90, 100, and 110 may include one or more fold areas 125 (such as for cover 120) as shown in FIG. 6E. The fold areas 125 may be crimped, indented, perforated, or include other pliability increasing mechanism(s) to enable the soil cover 120 to more readily fold at such fold areas 125. A soil cover 10, 20, 50, 60, 70, 80, 90, 100, and 110 may be passed through a plurality of rollers to increase its pliability and reduce wrinkles or breakage.

Soil covers may be formed in large rolls where sections may be cut accordingly to customer specifications. In such an embodiment a calculator may be provide near or attached to the large soil cover roll to enable a user to determine the linear feet of cover needed for their soil area to be covered. In an embodiment the width of the soil cover is an integer multiple of its length. Accordingly various soil cover architectures 130 may be configured for such a soil cover such as shown in FIG. 7. In FIG. 7 the soil cover length is equal to two times its width so three soil covers may placed in a simple configuration to cover a rectangular soil area. The soil covers 10 may be overlapped so stake openings 22 may be shared as shown in FIG. 7. A stake 40 may be employed in one or more openings 22 to hold architecture 130 in place. The soil covers may also have organic, biodegradable adhesive strips, along it periphery so adjacent soil covers can be adhered to each other.

While this invention has been described in terms of a best mode for achieving the objectives of the invention, it will be appreciated by those skilled in the art that variations may be accomplished in view of these teachings without deviating from the spirit or scope of the present invention. For example, a soil cover may be comprised of paper products and organic products including plant or tree leaves and corn husks. Further a soil cover may include any combination of the features of the soil covers 10, 20, 50, 60, 70, 80, 90, 100, 1 10. For example a soil cover 10, 50 may include any combination of stake perforations 22 (FIG. 1C), perimeter weighting 65 (FIG. 4A), embedded seeds, fertilizer, and insect repellant 75 (FIG. 5A), perforations 85 (FIG. 6A), edge saddle stitching 95 (FIG. 6B), row patches 105 (FIG. 6C), grid lines 115 (FIG. 6D), and fold areas 125 (FIG. 6E). In addition, one or more biodegradable layers may be formed by heat bonding, cut bonding, or pressure bonding substantially flat biodegradable material(s).

What is claimed is:

1. A soil cover, including:
a first biodegradable layer including:
a plurality of substantially flattenable biodegradable materials,
wherein the plurality of substantially flattenable biodegradable materials are bound together via one of heat bonding, cut bonding, pressure bonding, and gluing via a biodegradable bonding material to form the first biodegradable layer that is substantially flattenable and has a predetermined surface shape that when flattened may cover a predetermined soil surface area.

2. The soil cover according to claim 1, further including a second biodegradable layer including a second plurality of substantially flattenable biodegradable materials coupled to the first layer via one of heat bonding, cut bonding, pressure bonding, and gluing via a biodegradable bonding material.

3. The soil cover according to claim 2, wherein the first biodegradable layer and the second biodegradable layer are comprised substantially of biodegradable plant materials.

4. The soil cover according to claim 1, further including a weighted section along at least a section near or about a periphery of the soil cover.

5. The soil cover according to claim 4, wherein at least a portion of the weighted section includes sand.

6. The soil cover according to claim 1, further including a biodegradable bonding material, the bonding material bonding the plurality of biodegradable materials to form the first biodegradable layer that is substantially flattenable and has a predetermined surface shape that when flattened may cover a predetermined soil surface area.

7. The soil cover according to claim 2, wherein the first biodegradable layer and the second biodegradable layer are comprised substantially of one of leaves and corn husks.

8. The soil cover according to claim 1, wherein the first biodegradable layer is comprised substantially of newspaper.

9. The soil cover according to claim 2, wherein the first biodegradable layer and the second biodegradable layer are comprised substantially of newspaper.

10. The soil cover according to claim 9, further including a weighted section along at least a section near or about a periphery of the soil cover.

11. The soil cover according to claim 10, wherein at least a portion of the weighted section includes sand.

12. The soil cover according to claim 1, further including a one of a seed and fertilizer layer within a portion of the cover and between the first biodegradable first layer and the second biodegradable second layer.

13. The soil cover according to claim 1, further including a plurality of holes near or about a periphery of the soil cover, each hole dimensioned to receive a biodegradable stake.

14. The soil cover according to claim 1, further including at least one biodegradable stake and a plurality of holes near or about a periphery of the soil cover, each hole dimensioned to a biodegradable stake.

15. The soil cover according to claim 14, wherein the at least one biodegradable stake is comprised substantially of one of corn husks, biodegradable plastics, biodegradable starches, and wood.

16. The soil cover according to claim 1, further including an ink layer disposed on a substantial portion of the first biodegradable layer.

17. The soil cover according to claim 1, wherein the ink is a biodegradable ink.

18. The soil cover according to claim 1, wherein soil cover degrades over a planting season.

19. The soil cover according to claim 16, wherein the ink layer and the first biodegradable layer include one of a user viewable grid and other nomenclature on at least a portion of the soil cover surface area.

20. The soil cover according to claim 16, wherein the ink layer and the first biodegradable layer include user viewable planting patterns on at least a portion of the soil cover surface area.

21. The soil cover according to claim 16, wherein the ink layer and the first biodegradable layer include user viewable planting instructions on at least a portion of the soil cover surface area.

22. The soil cover according to claim 1, further including at least one fold area wherein the soil cover may be folded along the fold area.

23. The soil cover according to claim 1, wherein the soil cover includes a plurality of slits within a portion of the soil cover surface area.

24. The soil cover according to claim 1, wherein the soil cover includes a plurality of performations within a portion of the soil cover surface area.

25. The soil cover according to claim 1, wherein the soil cover surface area is rectangular.

26. The soil cover according to claim 25, wherein a first side length is an integer multiple of the second side length.

27. The soil cover according to claim 1, further including saddle stitching about a portion of a periphery of the soil cover.

28. A method of creating a soil cover having a predetermined surface shape that may cover a predetermined soil surface area, including bonding a plurality of substantially flattenable biodegradable materials via one of heat bonding, cut bonding, pressure bonding, and gluing via a biodegradable bonding material to form a first biodegradable layer that is substantially flattenable and has a predetermined surface shape that when flattened that may cover a predetermined soil surface.

29. The method of creating a soil cover according to claim 28, further including bonding a second plurality of substantially flattenable biodegradable materials via one of heat bonding, cut bonding, pressure bonding, and gluing via a biodegradable bonding material to form a second biodegradable layer and coupling to the first layer and the second biodegradable layer via one of heat bonding, cut bonding, pressure bonding, and gluing via a biodegradable bonding material.

30. The method of creating a soil cover according to claim 29, further including inserting a weighted section along at least a section near or about a periphery between the first biodegradable layer and the second biodegradable layer.

31. The method of creating a soil cover according to claim 29, wherein the first biodegradable layer is comprised substantially of newspaper and the second biodegradable layer is comprised substantially of newspaper.

32. The method of creating a soil cover according to claim 31, further including creating one of a seed and fertilizer layer within a portion of the cover and between the first biodegradable first layer and the second biodegradable second layer.

33. The method of creating a soil cover according to claim 32, further including creating a plurality of holes near or about a periphery of the soil cover, each hole dimensioned to receive a biodegradable stake.

34. The method of creating a soil cover according to claim 28, further including creating an ink layer disposed on a substantial portion of the first biodegradable layer.

35. The method of creating a soil cover according to claim 34, further including creating a user viewable grid on at least a portion of the soil cover surface area.

36. The method of creating a soil cover according to claim 34, further including creating a user viewable planting patterns on at least a portion of the soil cover surface area.

37. The method of creating a soil cover according to claim 34, further including creating a user viewable planting instructions on at least a portion of the soil cover surface area.

38. The method of creating a soil cover according to claim 28, further including creating a at least one fold area wherein the soil cover may be folded along the fold area.

39. The method of creating a soil cover according to claim 28, further including creating a plurality of slits within a portion of the soil cover.

40. The method of creating a soil cover according to claim 28, further including creating a plurality of performations within a portion of the soil cover surface area.

41. The method of creating a soil cover according to claim 28, further including creating a saddle stitching about a portion of the periphery of the soil cover.
